(19) United States
(12) Patent Application Publication
(10) Pub. No.: US 2008/0082611 A1
(43) Pub. Date: Apr. 3, 2008

(54) Unbiased information dissemination website

(76) Inventor: Sam Samaha, Sherman Oaks, CA (US)

Correspondence Address: TY UNG, 16830 VENTURA BLVD., SUITE 360, ENCINO, CA, 91436, US

(21) Appl. No.: 11/893,930

(22) Filed: Aug. 17, 2007

Related U.S. Application Data
(60) Provisional application No. 60/838,638, filed on Aug. 17, 2006.

(51) Int. Cl. G06F 15/16

(52) U.S. Cl. 709/204

(57) ABSTRACT

This invention relates generally to information dissemination web portals and more particularly to the dissemination of information where there is no advertisement and the person providing the information is unbiased. The information is unbiased because the person providing the information is an expert hired by the web portal provider and has no incentive to sell products or service to the user. The expert is therefore free to provide responses that are not geared towards the selling of a product or service.

### CROSS-REFERENCE TO RELATED APPLICATION

This application claims priority to provisional application No. 60/838,638 filed on Aug. 17, 2006.

### FEDERALLY SPONSORED RESEARCH

Not Applicable

### SEQUENCE LISTING OR PROGRAM

Not Applicable

### FIELD OF THE INVENTION

This invention relates to information dissemination over the internet and particularly, to the dissemination of information that is unbiased because the provider of the information has no outside interest other than providing information to the user since the expert providing the information is paid by the website provider and not by commission or advertisements. More particularly, method of providing unbiased information is targeted to homeownership and providing homeowners with information about homeownership that does not have advertising and is unbiased.

### BACKGROUND OF THE INVENTION

This invention relates generally to information dissemination and more particularly to the dissemination of information where there is no advertisement and the person providing the information has no interest in selling a product when providing the information. Numerous websites for providing information are in existent. Various methods for providing information are also available. However, methods for providing information that does not push a product or service, advertise to customers, or ask a customer to buy products when the information is provided is not currently available.

A challenge for most web user is to find information on the web while not being bombarded with advertisements. If the site providing the information does not have advertisements, the information that is provided to the consumer generally tries to sell a service or good by directing the information to a service or good that sponsors, promote or advertise on the site that is providing the information.

Because the consumers are bombarded with information that is geared to have the consumer purchase something, the information provided may not be in the best interest of the consumer. Therefore, there is a need to disseminate information that removes the need to advertise and provides information that is unbiased.

### BRIEF DESCRIPTION OF THE FIGURES

FIG. 1 is the front page of the web portal of the present invention where members can login to the web portal and read about the services provided.

FIG. 2 is the registration page where new users can sign up for access to the web portal of the present invention.

FIG. 3 is the question and answer inbox.

FIG. 4 is the question page.

FIG. 5 is the response display page.

### FIGURES

### Reference Numerals

100 . . . Member Login
200 . . . Registration Form
210 . . . Subscription Type
220 . . . Agent ID
300 . . . Question and Answer Inbox
310 . . . Ask Question
320 . . . Discounts
400 . . . Question Submittal Box
500 . . . Reply Display

### DETAILED DESCRIPTION

The present invention is a method for providing information through a web portal that is unbiased and does not direct the user posing the question to a product or service that they do not need. Because there is no selling by the person providing the response and the web portal has no interest in selling products to the user, the information is unbiased.

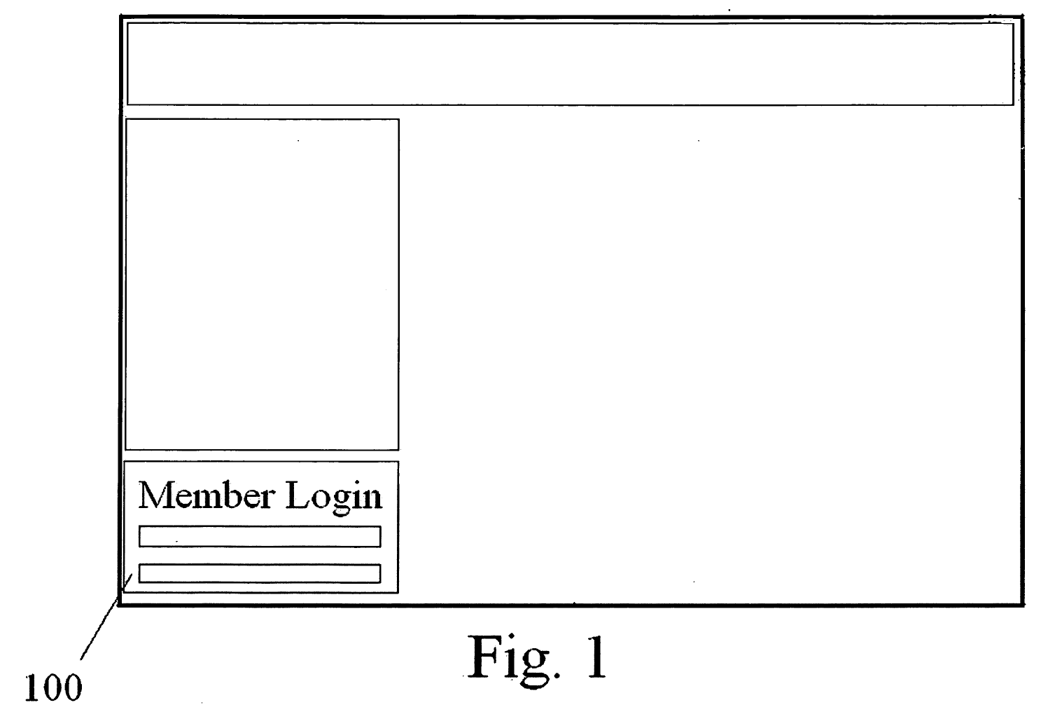

FIG. 1 through 5 shows the web portal of the present invention. Referring to FIG. 1, the method of the present invention is shown. In FIG. 1 the consumer is presented with a page in which they have the option of learning more about the services of the web portal of the present invention or login to the service if they already have membership. If the user is a member, the user enters the information required of them in member login 110 display box and clicks submit. This will allow the user to gain access to the member materials of the web portal of the present invention.

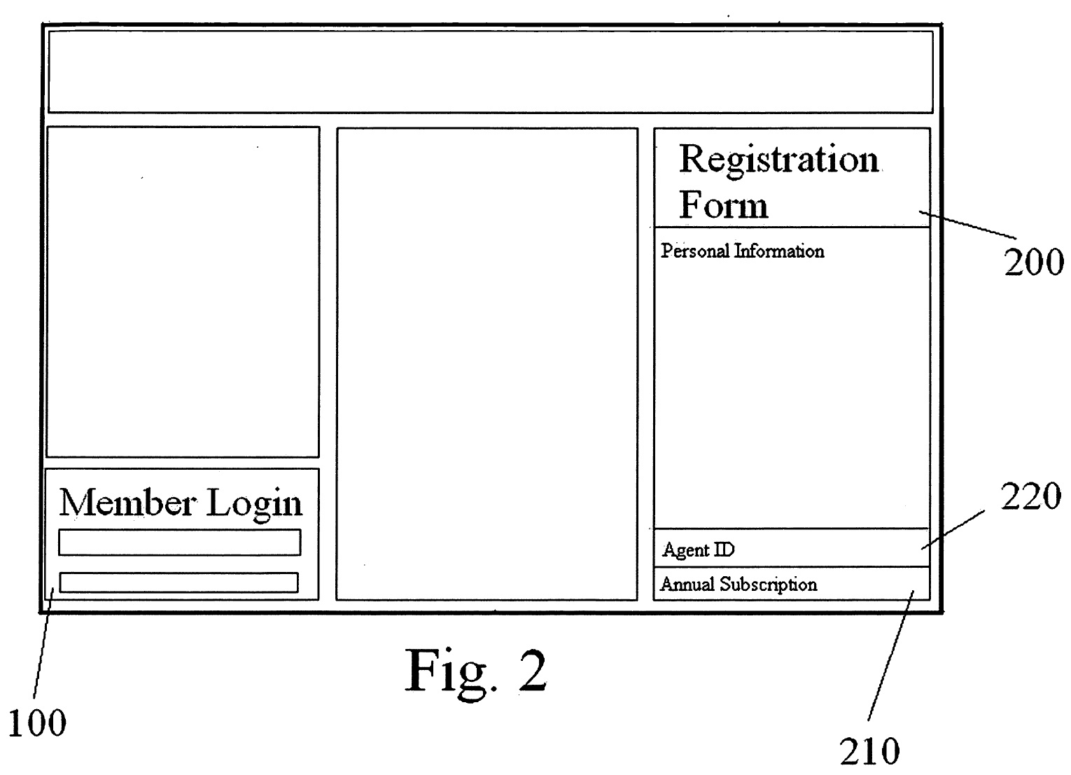

If a user is not yet a member, the user may go to the registration page as shown in FIG. 2 and sign up for an access account by completing a registration form 200 to obtain membership information and gain access to the web portal of the present invention. The registration form 200 requires that the user provide information such as their name and contact information, select the subscription type 210, and if applicable provide an agent ID 220 code if membership has been provided to the user by a business. Once the user has completed the registration form 200, the user becomes a registered user and can log onto the web portal and gain access to the unbiased information and question page.

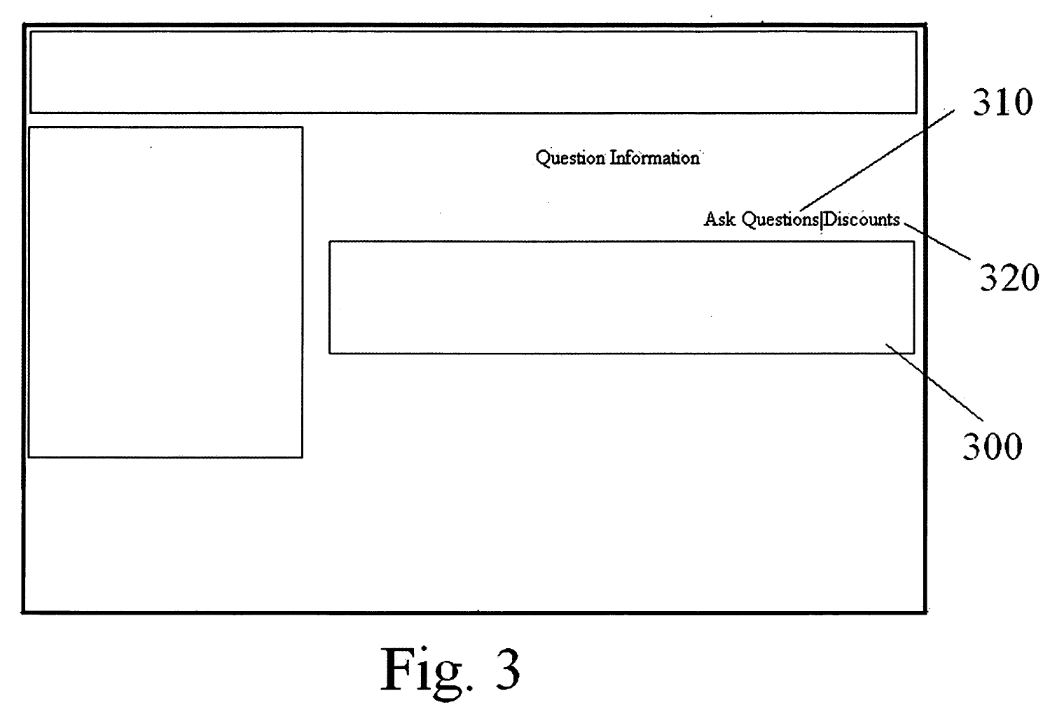

FIG. 3 shows the members page where the user can browse the web portal for information, view questions and answers in the question and answer inbox 300, ask question 310, or view available discounts 320. The discounts 320 may be sorted by the zip code. The question and answer inbox 300 contains asked questions and responses to the questions which can be viewed by the user. The user has the option to ask additional questions within the same category and obtain clarification on the question previously posted without being limited to the number of questions they can asked since the question is within the same category.

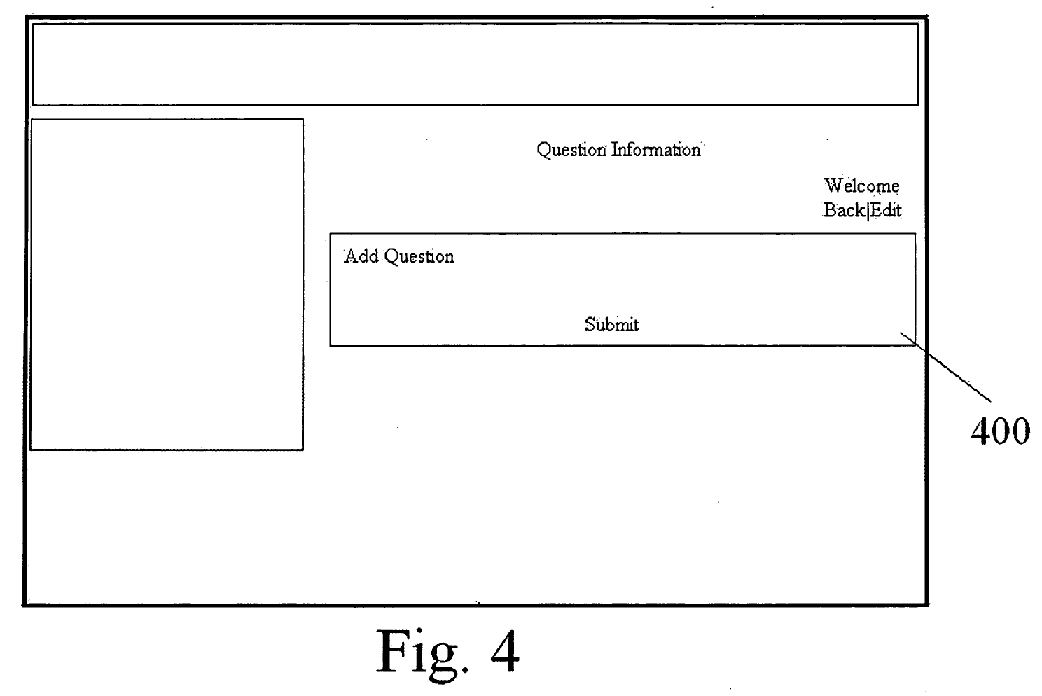

FIG. 4 shows the question submittal box 400 where the user can ask a question by typing it in the question submittal box 400 and clicking submit. The question is then transferred to an expert, consultants with expertise in the field related to the question submitted by the user, such as homeownership. The expert provides an answer by responding to the question from the user by providing a response that is targeted to the user's question.

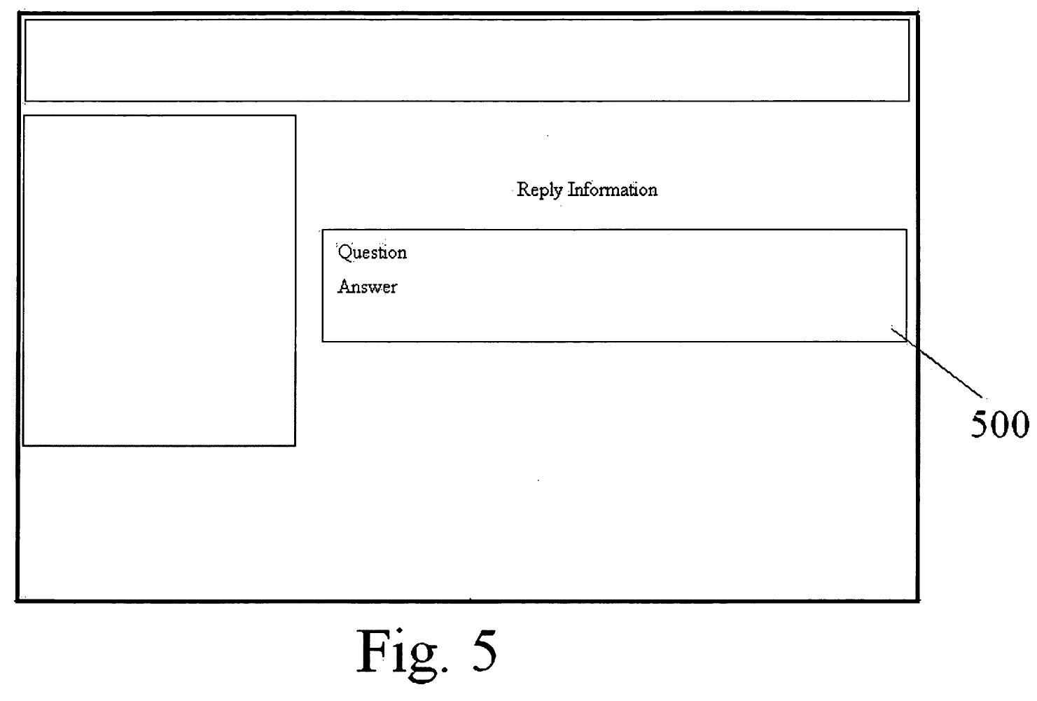

FIG. 5 shows the reply display 500 where the answer from the expert is displayed in the users account for the user to view. The reply display may contain the contact information of the provider of membership if the user entered an agent ID 220 during the initial registration process. The membership provider information is updated automatically whenever the membership provider's information is updated.

Additional questions and answers can be submitted and responded to in the same manner as described above. Throughout the whole process, there are no advertising in the web portal for providing unbiased information of the present invention. However, information about discounted services may be provided for the user to peruse.

For membership providers, such as a business, who want to provide their customers access to the web portal of the present invention, the business can provide for free or purchase premium membership for distribution to their customers. The business may sign up the client through the business' member page which will then automatically send a confirmation email to the client with the login information. On the other hand, the business may provide the client with an agent ID 220 code that the client can use when registering for access to the web portal of the present invention. While businesses can provide membership to their client, the consumer part of the present invention can be used as a standalone invention.

In the business part, a business signs up for an access account by providing their contact information. Once the business has an account, the business can log onto the web portal. On the web portal of the present invention, the business can obtain free or purchase premium membership. These additional memberships can be given to the customers of the business. Each membership has a code that corresponds to the business that obtained free or purchase premium membership.

To provide information that is unbiased, the present invention, utilizes a web portal with no advertisement and experts hired by the web portal owner, the expert being paid only by the web portal owner and not on commission or the amount of products/services sold. The present invention also works on different levels of membership that can be obtained for free or purchased premium membership either by the consumer or a business that would like to provide membership to their customers.

The web portal of the present invention may be used for providing information regarding home ownership, home repair, and any other matters that are related to the owning of a home. Therefore, users who have questions related to home ownership matters can ask these questions to experts in the field.

Additionally, members of the web portal of the present invention may earn points which can be used to obtain goods or services. These points may be earned through new member referrals or by using the web portal of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

While specific systems and methods have been disclosed in the preceding description, it should be understood that these specifics have been given for the purpose of disclosing the principles of the present invention and that many variations thereof will become apparent to those who are versed in the art.

I claim:

1. A method of providing unbiased information comprising:
A web portal for a user to enter a question through the web portal and relayed to an expert on the other end of the web portal;
The user submitting a question through a question submittal page on the web portal of the present invention;
The expert in the field of the question submitted by the user responds to the question by the user by providing a response that is targeted to the user's question.

2. The method of providing unbiased information of claim 1, further comprising:
The user signing up for an access account to the web portal;
The user logging onto the web portal of the present invention to gain access to the web portal and question submittal page.

3. The method of providing unbiased information of claim 2, wherein the user signs up for a subscription when signing up for access to the web portal.

4. The method of providing unbiased information of claim 1, wherein the user provides an agent ID if membership is provided to the user by a membership provider.

5. The method of providing unbiased information in claim 1, further comprising a business section wherein a business:
Signs up for membership on the web portal;
The business obtains additional memberships to provide to the user, where each membership has an agent ID.

6. The method of providing unbiased information in claim 1, wherein members can earn points which can be used to obtain goods or services.

7. The method of providing unbiased information of claim 5, wherein information about the business that provided the membership to the user is imprinted onto the response that is provided by the expert if the user was providing membership by the business.

8. The method of providing unbiased information in claim 1, wherein the web portal contains no advertisement.

9. The method of providing unbiased information in claim 1, wherein the expert is paid by the web portal owner and not paid on commission.

10. The method of providing unbiased information of claim 1, wherein the unbiased information is related to homeownership.

11. The web portal for providing unbiased information of claim 1, wherein the experts are experts in a field relating to homeownership.

12. The method of providing unbiased information of claim 1, further comprising a discount page containing information about available discounts.

13. A web portal for providing unbiased information to users comprising:
Experts hired by the web portal provider for responding to questions posed by users of the web portal;
A question page for submitting questions to the expert;
A reply display for displaying answers provided by the expert;
The web portal allowing the user to gain access to the web portal, question page, and reply display of the present invention.

14. The web portal for providing unbiased information of the present invention of claim 13, wherein the reply display shows the contact information about a business that provided the membership.

15. The web portal for providing unbiased information of the present invention of claim 13, wherein a business section is provided for the business to obtain membership for their customers.

16. The web portal for providing unbiased information of claim 15, wherein the membership obtained by the business contains an agent ID that can be provided to the business' customer such that when the customer uses the agent ID to sign up for membership and becomes a user, the contact information of the business will be displayed on every response that is provided to the customer.

17. The web portal for providing unbiased information of claim 13, wherein the information provided is related to homeownership.

18. The web portal for providing unbiased information of claim 13, wherein the user chooses a subscription type when signing up for access.

19. The web portal for providing unbiased information of claim 13, wherein information about discounts are provided to the user.

20. The web portal for providing unbiased information of claim 13, wherein the experts are experts in a field relating to homeownership.

21. The web portal for providing unbiased information of claim 20, wherein the expert is hired by the web portal provider.
